(19) United States
(12) Patent Application Publication
(10) Pub. No.: US 2008/0165737 A1
(43) Pub. Date: Jul. 10, 2008

(54) MOTION SENSITIVE SYSTEM SELECTION FOR MULTI-MODE DEVICES

(76) Inventor: Subramanya R. Uppala, Secunderabad (IN)

Correspondence Address: KYOCERA WIRELESS CORP., P.O. BOX 928289, SAN DIEGO, CA, 92192-8289, US

(21) Appl. No.: 11/621,442

(22) Filed: Jan. 9, 2007

(51) Int. Cl. H04Q 7/32; H04B 1/38

(52) U.S. Cl. 370/331; 455/73

(57) ABSTRACT

A wireless communication device is comprises a motion module that works in cooperation with a GPS module or other location sensing module to determine the type of motion currently affecting the wireless communication device. Depending on the type of motion, e.g., stationary, ambulatory, or vehicular, the wireless communication device prioritizes use of the various radio technologies available to the multi-mode device. Supplemental prioritization schemes such as user preference and signal strength can also be employed after any radio technologies may have been eliminated through motion sensing.

### FIELD OF THE INVENTION

The present invention generally relates to multi-mode wireless communication devices and more particularly relates to improved techniques for switching between various alternative radio technologies in a multi-mode wireless communication device.

### BACKGROUND

As multi-mode wireless communication devices emerge, there is a need to provide efficient and intelligent techniques for switching between the various radio technologies available to a device in order to provide the consumer with a seamless experience and preserve device resources such as the battery and CPU cycles.

The premise of a dual mode device in general is that one of the radio technologies (e.g., code division multiple access (“CDMA”)) is for use over a wireless wide area network (“WWAN”) with a broad range and another of the radio technologies is for use over a wireless local area network (“WLAN”) network with a more limited range. As more and more cities, counties and other regions push ahead to provide complete and comprehensive WLAN coverage in their cities, the WLAN radio technology is approaching status as a wide area network. This emerging availability of the geographically larger and larger WLAN coverage increases the complexity of network selection for multi-mode devices.

One significant drawback of increased WLAN availability is the dilemma posed on mobile multi-mode devices that approach a boundary between access points (“APs”) in a WLAN system. The multi-mode device must be sophisticated enough to determine whether it should make a handoff between two APs in the WLAN system or whether it should switch radio technologies in favor of WWAN communications. Accordingly, the improving infrastructure for wireless communications has created a need for a system and method that addresses the needs of consumers.

### SUMMARY

Described herein are a system and method for determining the current motion of a multi-mode wireless communication device and constructing a motion model that is used to determine which of the various radio technologies available to the multi-mode device is to be used. A multi-mode wireless communication device is configured with a motion module that works in cooperation with a GPS module or other location sensing module to determine the type of motion currently associated with the wireless communication device. Depending on the type of motion, e.g., stationary, ambulatory, or vehicular, the multi-mode wireless communication device prioritizes which of the various radio technologies available to the multi-mode device are to be used.

Accordingly, when the movement of the user is vehicular, the multi-mode wireless communication device can turn off the WLAN radio technology in favor of the broader geographical range and more efficient WWAN radio technology. Alternatively, when the user is stationary or ambulatory, both WLAN and WWAN radio technologies can be efficiently employed and therefore supplemental prioritization schemes such as user preference, signal strength, or cost can be used to select the preferred radio technology. Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example multi-mode wireless communication device in communication over a wireless wide area network and a wireless local area network according to an embodiment of the present invention;

FIG. 2 is a block diagram illustrating an example multi-mode wireless communication device according to an embodiment of the present invention;

FIG. 3 is a flow diagram illustrating an example process for motion sensitive radio technology selection according to an embodiment of the present invention;

FIG. 4 is a flow diagram illustrating an example process for determining a motion type according to an embodiment of the present invention; and

FIG. 5 is a block diagram illustrating an example multi-mode wireless communication device that may be used in connection with various embodiments described herein.

### DETAILED DESCRIPTION

Certain embodiments as disclosed herein provide for a multi-mode wireless communication device configured to prioritize and select the preferred radio technology based on a motion model constructed based on the device's determined motion. For example, one method as disclosed herein allows for a multi-mode wireless communication device to determine its type of motion as stationary, ambulatory, or vehicular and if the determined motion is vehicular the device gracefully shuts down its WLAN radio technology and uses its WWAN radio technology during vehicular movement.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

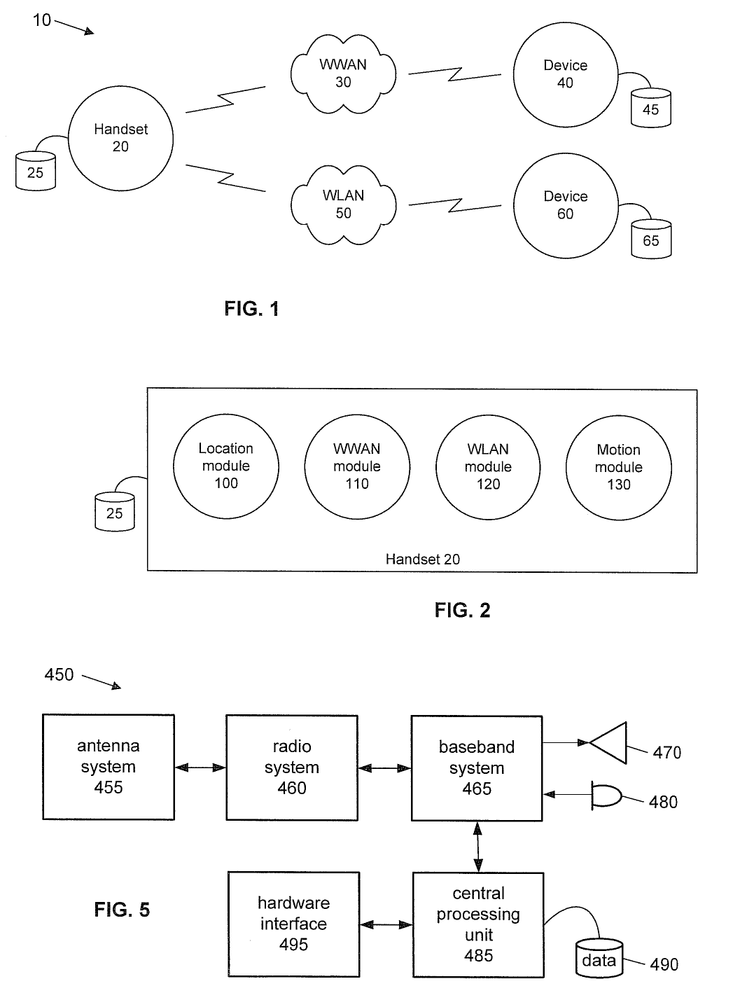

FIG. 1 is a network diagram illustrating an example multi-mode device in communication over a wireless wide area network (“WWAN”) and a wireless local area network (“WLAN”) according to an embodiment of the present invention. In the illustrated embodiment, the system 10 comprises a multi-mode wireless communication device 20 (also referred to herein as a handset), a WWAN 30, a WLAN 50, and a two network devices 40 and 60, respectively. The handset 20 and each of the network devices 40 and 60 are configured with respective data storage areas 25, 45, and 65.

The handset 20 is capable of being communicatively coupled with one or both of the WWAN 30 and the WLAN 50. The WWAN 30 is configured for voice and data communications (e.g., with device 40) over a wide geographical area, for example using CDMA. The WLAN 50 is configured for voice and data communications (e.g., with device 60) over a more limited geographical area, for example using one or more of the IEEE 802 communication standards such as 802.11a/b/g. The WWAN 30 or the WLAN 50 can also be communicatively coupled with a public or private network (not shown), which may include that particular aggregation of networks commonly known as the Internet.

The handset 20 can be any of a variety of wireless communication devices, including a cell phone, personal digital assistant (“PDA”), personal computer (“PC”), laptop computer, PC card, special purpose equipment, or any combination of these and other devices capable of establishing a wireless communication link over a wireless communication network such as WWAN 30 and WLAN 50. The handset 20 is configured for wireless communication over a plurality of radio technologies including (by example only and without limitation), 802.1×WLAN networks, CDMA networks, global system for communication (“GSM”) networks, and the like. In one embodiment, the handset may be configured for simultaneous communication over a plurality of radio technologies.

The data storage areas 25, 45, and 65 can be any sort of internal or external memory device and may include both persistent and volatile memories. The function of the respective data storage areas 25, 45, and 65 is to maintain data for long term storage and also to provide efficient and fast access to instructions for applications that are executed by the respective devices.

FIG. 2 is a block diagram illustrating an example multi-mode wireless communication device 20 according to an embodiment of the present invention. In the illustrated embodiment, the handset 20 comprises a location module 100, a WWAN module 110, a WLAN module 120, and a motion module 130. The handset 20 is also configured with a data storage area 25, as previously described with respect to FIG. 1.

The location module 100 is configured to identify the location of the handset 20 over time and determine the speed at which the handset is moving. Alternatively the location module may be configured to determine the speed at which the handset is moving relative to a particular object, for example a wireless network access point (“AP”). The distinction between absolute motion of the handset 20 and relative motion of the handset can be significant, for example, when the handset 20 is stationary relative to a WLAN access point on a train that is traveling a high velocity. In such a situation, the absolute speed of the handset 20 would be very high (vehicular) while the relative speed of the handset 20 would be stationary. The location module 100 is configured to determine the absolute and relative speed of the handset 20.

In one embodiment, the location module 100 uses a GPS module (not shown) on the handset 20 to identify the location of the handset 20 over time and determine the relative or absolute speed of the handset. Alternatively, the location module 100 may use other location techniques to identify the location of the handset, such as triangulation, for example. Alternative embodiments of the location module 100 may use different techniques for identifying the location of the handset 20, but the function of the location module 100 remains determining the absolute and/or relative speed of the handset 20.

The WWAN module 110 is configured to establish and maintain voice and/or data communications between the handset 20 and a WWAN network, as is well understood in the art. The WLAN module 120 is configured to establish and maintain voice and/or data communications between the handset 20 and a WLAN network, as is also well understood in the art. These modules may interact with separate physical radios or they may compete for a single radio capable of communication over multiple frequencies (e.g., a software defined radio).

The motion module 130 is configured to determine whether the current relative or absolute speed of the handset 20 exceeds a predetermined threshold that indicates that one or another radio technologies is preferred for communication. For example, if the handset 20 is traveling a high velocity then the motion module 130 may determine that the WWAN module 120 should be used for communication. In such a case, the motion module 130 may instruct the handset 20 to power down the WLAN module 130 in order to conserve system resources such as battery power and central processing unit (“CPU”) cycles.

Alternatively, in the train example above, the motion module 130 may determine that the absolute speed of the handset 20 is high velocity (i.e., vehicular) but that the relative speed of the handset 20 is stationary and therefore instruct the handset 20 that communication over the WLAN module 130 is preferable or that communication over either the WWAN module 120 or the WLAN module 130 is acceptable. In such a case, when two or more radio technologies are acceptable for communication, then the handset 20 can determine what radio technology to use based on other considerations such as user preferences or cost.

The motion module 130 may also be configured to prompt the user for real time input as to which radio technology is preferred. Additionally, the motion module 130 (or some other module on the handset 20) may be configured to detect and process unsolicited input from the user that provides a mechanism for a manual override by the user and specific instruction as to which radio technology to use.

In one embodiment, the motion module 130 works in combination with the location module 100 to make a recommendation to the handset 20 (or the user) regarding which radio technology should be used. Advantageously, the motion module 130 can facilitate shutting down one or more currently not preferred radio interfaces to enable the handset 20 to conserve its limited resources.

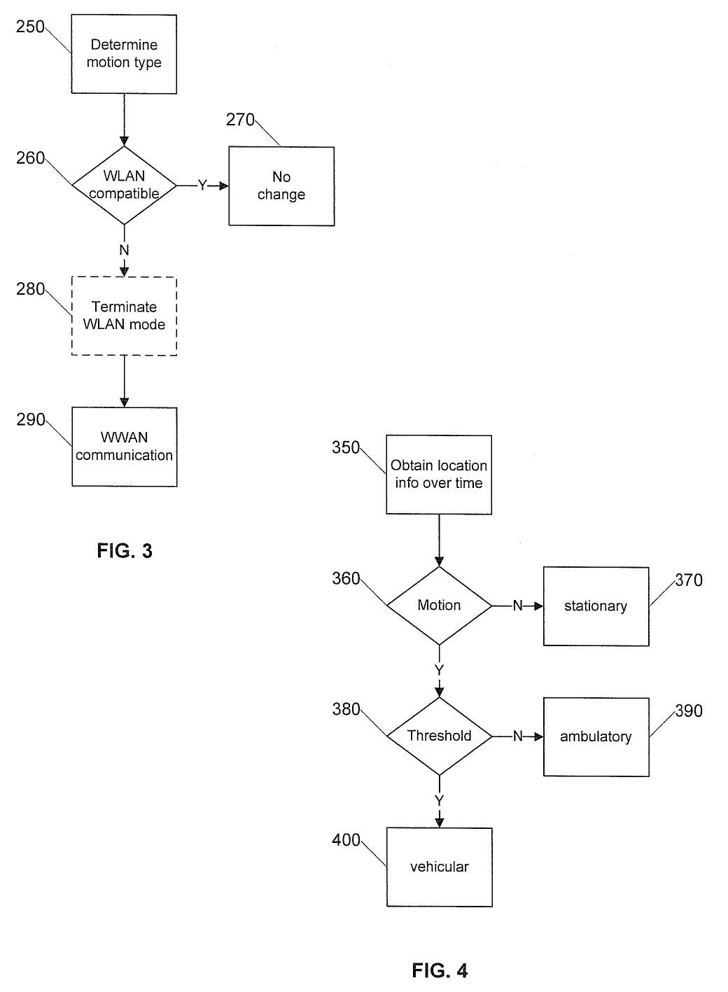

FIG. 3 is a flow diagram illustrating an example process for motion sensitive radio technology selection according to an embodiment of the present invention. The illustrated process may be carried out by a handset such as the handset previously described with respect to FIG. 2. Initially, in step 250 the handset determines its motion type. Advantageously, the handset is configured with a location sensing capability and repetitive location sensing is employed to identify the location of the device over time and thereby determine the speed of the device and categorize its movement as stationary, ambulatory, or vehicular. Because multi-mode wireless communication devices are typically used when the user is stationary, ambulatory (e.g., walking, jogging, cycling) or in a vehicle (e.g., high velocity movement), the determined type of motion can fall on a continuum categorized into these types of movement.

Additionally, the motion type can be relative or absolute. Relative motion can be determined relative to a particular object like an access point while absolute motion is the motion of the handset with respect to the earth.

Once the motion type is determined, the handset next determines whether the motion type is compatible with WLAN communications. For example, high velocity vehicular movement is generally not compatible with WLAN communications because the nature of WLAN communications is that the range of a WLAN network access point is small enough that the need for hand off (also referred to as hand-overs) between access points would arise quickly and often as the handset moved at high speed throughout the geographic region of the WLAN. If, as determined in step 260, the speed of the handset is compatible for WLAN communications (e.g., the speed is stationary or ambulatory) then no changes are made or recommended, as shown in step 270.

If, however, the speed of the handset as determined in step 260 is not compatible with WLAN communications (e.g., the speed is vehicular) then the WWAN radio technology is more efficient and therefore preferred. Accordingly in optional step 280, the WLAN mode (e.g., the WLAN radio) can be shut down during the vehicular movement in order to conserve resources on the handset. Alternatively, if there is only one radio in the handset, then in step 290 the handset switches over to WWAN communications. In one embodiment, the radio in the handset can be reconfigured with software to communicate over the WWAN. In such an embodiment the WLAN mode would be necessarily terminated in order to switch to WWAN mode. Additionally, the handset may also gracefully switch into WWAN mode such that any current communication sessions are maintained across the switch from the WLAN mode to the WWAN mode.

FIG. 4 is a flow diagram illustrating an example process for determining a motion type according to an embodiment of the present invention. The illustrated process may be carried out by a handset such as the handset previously described with respect to FIG. 2. Initially, in step 350 the handset obtains its location repetitively over time. The handset may obtain its location in a variety of ways, including GPS, triangulation, or receiving its location from the network. Next, in step 360 the handset determines whether or not it is in motion. If the handset is not in motion then in step 370 the handset determines that its motion type is stationary.

However, if the handset determines in step 360 that it is in motion, then in step 380 the handset determines if the speed of its motion exceeds a particular threshold. The handset may determine this for either absolute motion or relative motion, or both. If the relative or absolute speed of the handset does not exceed the threshold, then in step 390 the handset determines that its motion type is ambulatory.

If the handset determines in step 380 that the speed of its motion does exceed the designated threshold, then in step 400 the handset determines that its motion type is vehicular. Note that in certain circumstances, the motion type determined by the handset may be overridden by the user. Additionally, when the absolute motion of the handset exceeds the threshold but the relative motion of the handset does not exceed the threshold, the handset may determine that the motion type is ambulatory or stationary or the handset may query the user to make the determination. For example, if user preferences on the handset indicate that WLAN communications are preferred over WWAN communications and the absolute motion of the handset is vehicular but the relative motion of the handset to a WLAN access point is stationary (recall the train example), then the handset may determine that the motion type of the handset is stationary and communicate using the WLAN radio technology.

FIG. 5 is a block diagram illustrating an example wireless communication device 450 that may be used in connection with various embodiments described herein. As will be clear to those skilled in the art, other wireless communication devices and/or architectures may also be used.

In the illustrated embodiment, wireless communication device 450 comprises an antenna system 455, a radio system 460, a baseband system 465, a speaker 464, a microphone 470, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIG. 2.

In this description, the term “computer readable medium” is used to refer to any media used to provide executable instructions (e.g., software and computer programs) to the wireless communication device 450 for execution by the central processing unit 485. Examples of these media include the data storage area 490, microphone 470 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for motion sensitive radio technology selection executed by a multi-mode wireless communication device, comprising:
identifying a first radio technology in current use by the multi-mode wireless communication device;
determining a current motion type for the multi-mode wireless communication device;
comparing the determined motion type to the identified first radio technology;
determining that the first radio technology is not compatible with the current motion type based upon the comparison; and
switching from the first radio technology to a second radio technology in response to the determination.

2. The method of claim 1, wherein the switching step further comprises selecting the second radio technology from one or more radio technologies identified as compatible with the determined motion type.

3. The method of claim 1, wherein the determining a current motion type step further comprises:
obtaining a plurality of locations of the multi-mode wireless communication device over time;
determining a speed of the multi-mode wireless communication device based on the plurality of locations;
comparing the speed of the multi-mode wireless communication device to a threshold; and
determining that the speed of the multi-mode wireless communication device exceeds the threshold.

4. The method of claim 3, wherein determining the speed of the multi-mode wireless communication device comprises determining the speed relative to an object.

5. The method of claim 4, wherein the object is a wireless network access point.

6. The method of claim 3, wherein determining the speed of the multi-mode wireless communication device comprises determining the absolute speed.

7. A multi-mode wireless communication device configured for wireless communication over a plurality of radio technologies, the multi-mode wireless communication device comprising:
a wireless wide area network (WWAN) module configured to establish and maintain wireless communications over a WWAN;
a wireless local area network (WLAN) module configured to establish and maintain wireless communications over a WLAN;
a location module configured to determine the location of the multi-mode wireless communication device; and
a motion module configured to receive location information from the location module and determine a speed of the multi-mode wireless communication device, wherein the speed of the multi-mode wireless communication device determines the priority for communicating using one of the WWAN module and the WLAN module.

8. The device of claim 7, wherein the location module is configured to determine the location of the multi-mode wireless communication device using global positioning system measurements.

9. The device of claim 7, wherein the location module is configured to determine the location of the multi-mode wireless communication device using triangulation measurements.

10. The device of claim 7, wherein the location module is configured to receive the location of the multi-mode wireless communication device from the network.

11. The device of claim 7, wherein the motion module is configured to determine the absolute speed of the multi-mode wireless communication device.

12. The device of claim 7, wherein the motion module is configured to determine the speed of the multi-mode wireless communication device relative to an object.

13. The device of claim 12, wherein the object is a wireless network access point.

14. The device of claim 7, wherein the motion module is configured to switch communications on the multi-mode wireless communication device from the WLAN module to the WWAN module based on the speed of the multi-mode wireless communication device.

15. The device of claim 14, wherein the speed exceeds a predetermined threshold.

16. The device of claim 15, wherein the predetermined threshold is greater than 10 miles per hour.
